(19) United States
(12) Patent Application Publication
(10) Pub. No.: US 2013/0148068 A1
(43) Pub. Date: Jun. 13, 2013

(54) LIQUID CRYSTAL DISPLAY

(71) Applicant: Norihisa MAEDA, Nonoichi-shi (JP)

(72) Inventor: Norihisa MAEDA, Nonoichi-shi (JP)

(21) Appl. No.: 13/705,370

(22) Filed: Dec. 5, 2012

(30) Foreign Application Priority Data
Dec. 7, 2011 (JP) 2011-267686

(51) Int. Cl. G02F 1/1343; G02F 1/1333

(52) U.S. Cl. CPC G02F 1/134309; G02F 1/133345
USPC 349/138; 349/141

(57) ABSTRACT

According to one embodiment, a liquid crystal display includes a first substrate including a pixel electrode including a plurality of comb pixel electrodes, a common electrode including a plurality of comb common electrodes arranged between the plurality of comb pixel electrodes such that predetermined spaces are formed between the plurality of comb pixel electrodes and the plurality of comb common electrodes, and a recess formed between and along the comb pixel electrode and the comb common electrode, a second substrate opposing the first substrate, and a liquid crystal layer held between the first substrate and the second substrate.

### CROSS-REFERENCE TO RELATED APPLICATIONS

This application is based upon and claims the benefit of priority from Japanese Patent Application No. 2011-267686, filed Dec. 7, 2011, the entire contents of which are incorporated herein by reference.

### FIELD

Embodiments described herein relate generally to a liquid crystal display.

### BACKGROUND

Recently, flat displays are extensively developed, and liquid crystal displays are particularly applied to various fields by making use of features such as light weight, flatness, and low power consumption. A liquid crystal display like this has a structure in which a liquid crystal layer is held between a pair of substrates, and controls the modulation factor to light passing through the liquid crystal layer by an electric field between a pixel electrode and common electrode, thereby displaying an image.

The liquid crystal displays are classified into plural types of displays. One is a display in which the alignment state of a liquid crystal is controlled by applying, to the liquid crystal layer, a longitudinal electric field almost perpendicular to the substrate surfaces of the pair of substrates. The other one is a display in which the alignment state of a liquid crystal is controlled by applying, to the liquid crystal layer, a transverse electric field (including a fringe electric field) almost parallel to the substrate surfaces of the pair of substrates.

The liquid crystal display using the transverse electric field is particularly attracting attention from the viewpoint of a wide viewing angle. The transverse electric field type liquid crystal display having an In-Plane Switching (IPS) mode or Fringe Field Switching (FFS) mode includes pixel electrodes and common electrodes formed on a first substrate.

In the IPS-mode liquid crystal display, the pixel electrodes and common electrodes are spaced apart and juxtaposed in a direction almost parallel to the substrate surfaces, and a transverse electric field generated between the pixels electrode and common electrode controls the alignment state of liquid crystal molecules.

### BRIEF DESCRIPTION OF THE DRAWINGS

FIG. 1 is a schematic view showing an arrangement example of a liquid crystal display of an embodiment;

FIG. 2 is a schematic view showing an arrangement example of a display pixel of the liquid crystal display shown in FIG. 1;

FIG. 3 is a view for explaining an arrangement example of an array substrate of the liquid crystal display of the embodiment;

FIG. 4 is a graph showing an example of the simulation result of a normalized modulation factor with respect to a potential difference [V] between a comb pixel electrode and comb common electrode;

FIG. 5 is a graph showing an example of the simulation result of the change in normalized transmittance with time; and

FIG. 6 is a table showing the simulation result shown in FIG. 5, i.e., showing the time required for the transmittance to reach 0.9 from 0.1 when the voltage was ON, the time required for the transmittance to reach 0.1 from 0.9 when the voltage was OFF, and the sum of these times.

### DETAILED DESCRIPTION

In general, according to one embodiment, a liquid crystal display comprises a first substrate comprising a pixel electrode including a plurality of comb pixel electrodes, a common electrode including a plurality of comb common electrodes arranged between the plurality of comb pixel electrodes such that predetermined spaces are formed between the plurality of comb pixel electrodes and the plurality of comb common electrodes, and a recess formed between and along the comb pixel electrode and the comb common electrode; a second substrate opposing the first substrate; and a liquid crystal layer held between the first substrate and the second substrate.

A liquid crystal display of an embodiment will be explained below with reference to the accompanying drawings.

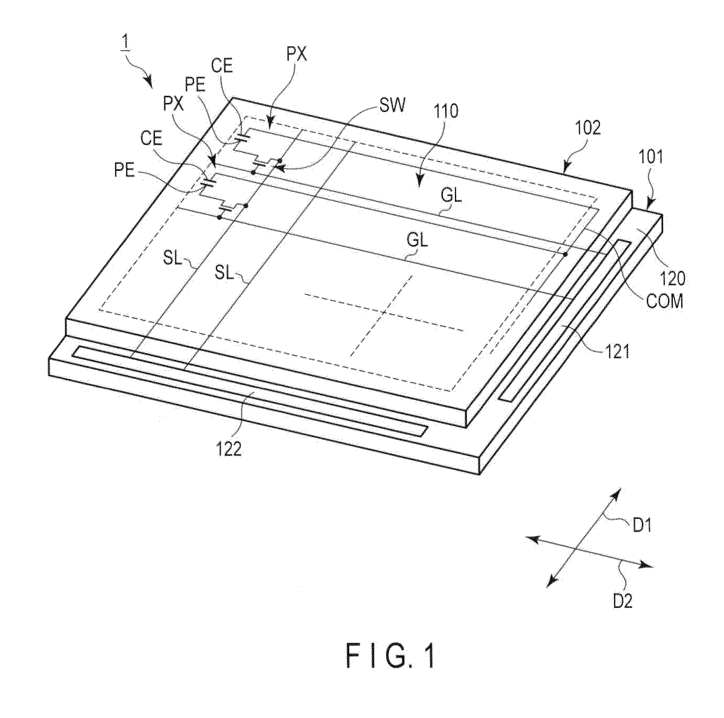

FIG. 1 is a schematic view showing an arrangement example of a liquid crystal display 1 of this embodiment. The liquid crystal display 1 according to this embodiment is a normally-black, IPS-mode liquid crystal display, and includes a pair of opposing substrates, i.e., a first substrate 101 and second substrate 102, a liquid crystal layer (not shown) held between the first substrate 101 and second substrate 102, and a display unit 110 including display pixels PX arranged in a matrix. Each of the first substrate 101 and second substrate 102 includes a light-transmitting insulating substrate such as a glass substrate.

In the display unit 110, the first substrate 101 includes a plurality of scanning lines GL running along a row direction (second direction) D2 in which the display pixels PX are arranged, a plurality of signal lines SL running along a column direction (first direction) D1 in which the display pixels PX are arranged, pixel switches SW arranged near the intersections of the scanning lines GL and signal lines SL, a plurality of pixel electrodes PE formed in one-to-one correspondence with the display pixels PX, and common electrodes CE so arranged as to form transverse electric fields between the plurality of pixel electrodes PE and common electrodes CE.

On the first substrate 101, a gate driver 121 and source driver 122 are arranged in a region around the display unit 110. The plurality of scanning lines GL are extended to the region around the display unit 110, and connected to the gate driver 121. The plurality of signal lines SL are extended to the region around the display unit 110, and connected to the source driver 122.

The gate driver 121 sequentially drives the plurality of scanning lines GL, thereby electrically connecting the source and drain of each pixel switch SW connected to the scanning line GL. The source driver 122 supplies an image signal to the plurality of signal lines SL. This image signal supplied to each signal line SL is supplied to the pixel electrode PE via the corresponding pixel switch. A common voltage is applied to the common electrodes CE via a common line COM.

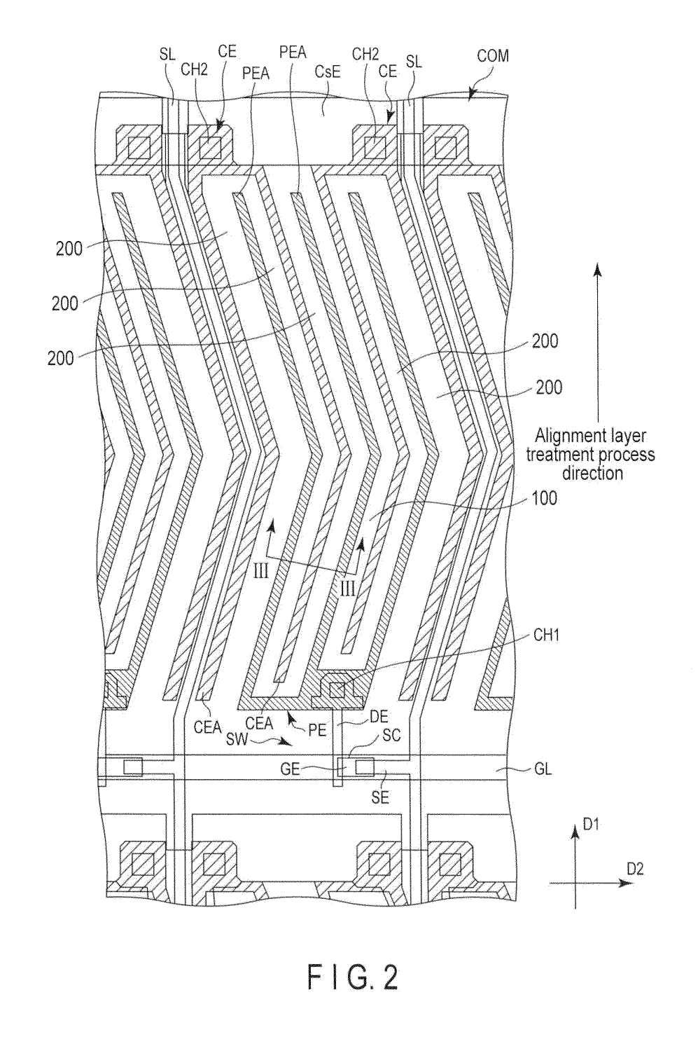

FIG. 2 is a plan view for explaining an arrangement example of the display pixel PX.

The pixel switch SW is a thin-film transistor including a semiconductor layer SC made of, e.g., amorphous silicon. Note that the pixel switch SW may also be a thin-film transistor including a polysilicon semiconductor layer. A gate electrode GE of the pixel switch SW is electrically connected to (or integrated with) a corresponding scanning line GL. A source electrode SE of the pixel switch SW is electrically connected (or integrated with) a corresponding signal line SL. In the liquid crystal display 1 according to this embodiment, the pixel switch SW includes two source electrodes. A drain electrode DE of the pixel switch SW is connected to a corresponding pixel electrode PE via a contact hole CH1.

The pixel switch SW whose gate potential is controlled by the scanning line GL formed on one side along the first direction D1 switches the electrical connections of the pixel electrode PE to the signal line SL.

The pixel electrode PE is formed into the shape of a comb by using a transparent electrode material such as ITO (indium tin oxide) or IZO (indium zinc oxide), and includes a plurality of comb pixel electrodes PEA extending almost parallel to the first direction D1 in which the display pixels PX are arranged. Each of the plurality of comb pixel electrodes PEA bends in an almost central portion of the display pixel PX in the longitudinal direction (first direction D1), and extends into the shape of “>”.

The common electrode CE is formed into the shape of a comb by using a transparent electrode material such as ITO (indium tin oxide) or IZO (indium zinc oxide), and includes a plurality of comb common electrodes CEA extending almost parallel to the first direction D1 in which the display pixels PX are arranged. Each of the plurality of comb common electrodes CEA bends in an almost central portion of the display pixel PX in the longitudinal direction (first direction D1), and extends into the shape of “>”. The common electrode CE is electrically connected to the common line COM (to be described later) in a contact hole CH2.

Note that the signal lines SL are illustrated as straight lines in FIG. 1, but each signal line SL bends in an almost central portion of the display pixel PX in the longitudinal direction as shown in FIG. 2, like the shape of the comb pixel electrode PEA of the pixel electrode PE and the comb common electrode CEA of the common electrode CE.

In the same layer as that of the scanning line GL, the common line COM runs almost parallel to the direction (second direction D2) in which the scanning line GL runs. The common line COM is electrically connected to the common electrodes CE arranged for a plurality of pixel electrodes PX arranged in the second direction D2, and applies a common voltage to the common electrodes CE.

The comb pixel electrodes PEA of the pixel electrodes PE and the comb common electrodes CEA of the common electrodes CE are alternately arranged at predetermined spaces in the second direction D2 in which the display pixels PX are arranged.

In this embodiment, recesses 200 are formed between the comb pixel electrodes PEA and comb common electrodes CEA. The recesses 200 extend along the comb pixel electrodes PEA and comb common electrodes CEA.

In the display unit 110, the second substrate 102 includes light-shielding layers (not shown) arranged in the form of a lattice so as to oppose the signal lines SL and scanning lines GL, and a light-shielding layer (not shown) formed to surround the display unit 110. When the liquid crystal display is a color display type liquid crystal display, the second substrate 102 includes a color filter layer (not shown).

The color filter layer includes a red color filter (not shown) for transmitting light whose dominant wavelength is red, a green color filter (not shown) for transmitting light whose dominant wavelength is green, and a blue color filter (not shown) for transmitting light whose dominant wavelength is blue. Each of these color filters for the plurality of colors is so formed as to oppose one pixel electrode PE.

A pair of alignment films (not shown) opposing each other with the liquid crystal layer being held between them are formed on the first substrate 101 and second substrate 102. To regulate the initial alignment direction of liquid crystal molecules contained in the liquid crystal layer, an aligning process such as a rubbing process or optical aligning process is performed on the surfaces of these alignment films in a predetermined direction.

A transverse electric field generated by the potential difference between an image signal supplied to the comb pixel electrodes PEA and the common voltage applied to the comb common electrodes CEA controls the alignment state of the liquid crystal layer.

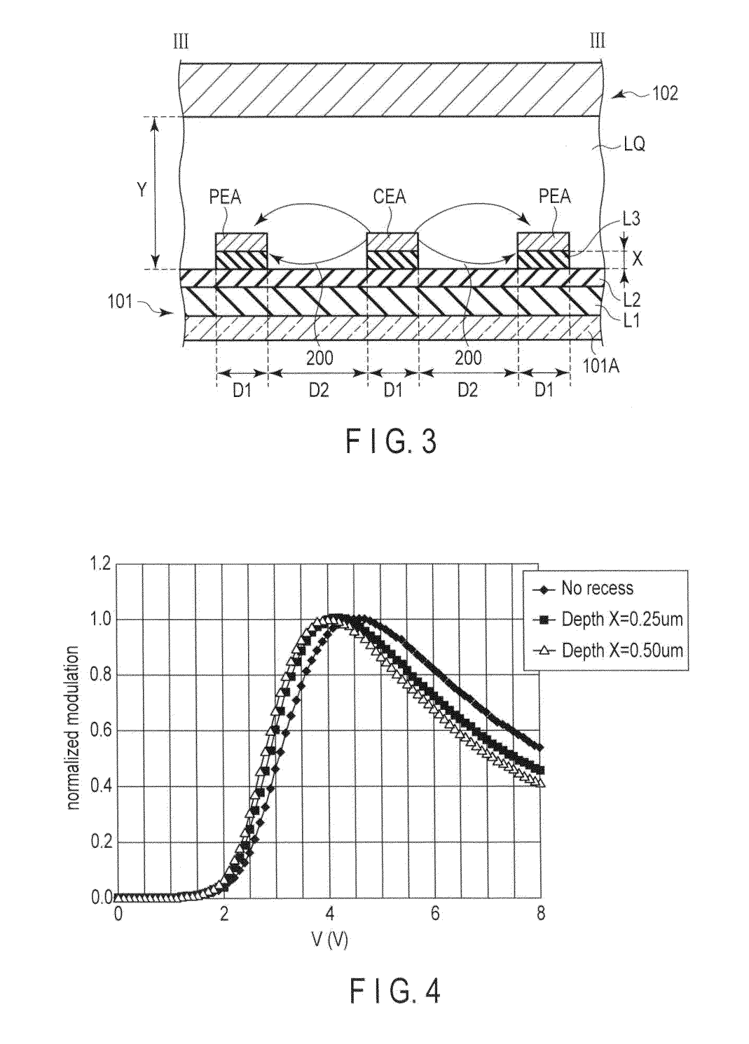

FIG. 3 is a view for explaining an arrangement example of the first substrate 101 along a line III-III. The first substrate 101 includes a transparent insulating substrate 101A such as glass, a semiconductor layer (not shown) formed on the transparent insulating substrate 101A, a gate insulating layer L1 formed on the semiconductor layer, the scanning lines GL formed on the gate insulating layer L1, an insulating layer L2 formed on the scanning lines GL, the signal lines SL formed on the insulating layer L2, an insulating layer L3 formed on the signal lines SL, and the comb pixel electrodes PEA and comb common electrodes CEA formed on the insulating layer L3. The insulating layers L1 to L3 are made of, e.g., silicon nitride or HRC.

The recesses 200 are formed by removing the insulating layer L3 between the comb pixel electrodes PEA and comb common electrodes CEA. When the recesses 200 are formed, the component on the side of the first substrate 101 of an electric field generated between the comb pixel electrode PEA and comb common electrode CEA can be used to control the alignment of a liquid crystal.

Note that the recesses 200 are formed by removing the insulating layer L3 in FIG. 3, but a plurality of insulating layers may also be removed in accordance with a depth X of the recesses 200. Also, at least one of the insulating layers L1 to L3 need only be removed in the recesses 200. Furthermore, it is also possible to form, on the insulating layer L3, another insulating layer as an underlayer of the comb pixel electrodes PEA and comb common electrodes CEA, and then form the recesses 200.

An example of the result of simulation performed on the modulation factor with respect to the potential difference [V] between the comb pixel electrode PEA and comb common electrode CEA and the response speed in the liquid crystal display in which the recesses 200 were formed as described above will be explained below.

In this simulation, the alignment film was rubbed in a direction at an angle of 7° to the direction in which the comb pixel electrodes PEA and comb common electrodes CEA run, dielectric anisotropy Δε of the liquid crystal was set at 9.0, and refractive-index anisotropy An of the liquid crystal was set at 0.103 (550 [nm]).

Also, simulation was performed by changing the depth X of the recess 200 to 0, 0.25, and 0.50 [μm] in a liquid crystal display in which the electrode width D1 of the comb pixel electrode PEA and comb common electrode CEA was 3.0 [μm], the distance D2 between the electrodes was 5.0 [μm], and a distance (cell gap) Y between the first substrate 101 and second substrate 102 was 3.4 [μm].

FIG. 4 is a graph showing an example of the simulation result of a normalized modulation factor with respect to the potential difference [V] between the comb pixel electrode PEA and comb common electrode CEA. According to this simulation result, the peak modulation factor when the depth X of the recess 200 was 0 [μm] (when no recess 200 was formed) was higher than those when the depth X of the recess 200 was 0.25 [μm] and 0.50 [μm].

On the other hand, a voltage at which the modulation factor was highest decreased as the depth X of the recess 200 increased, and the modulation factor when the recesses 200 were formed was higher than that when no recess 200 was formed until the potential difference [V] between the comb pixel electrode PEA and comb common electrode CEA reached 4 [V].

This is so presumably because when the recesses 200 were formed, an electric field on the side of the first substrate 101, among electric fields generated between the comb pixel electrode PEA and comb common electrode CEA, was used to modulate the liquid crystal, so the modulation factor was high at a low voltage. As described above, when the recesses 200 are formed, the same modulation factor can be obtained by driving at a voltage lower than that when no recess 200 is formed.

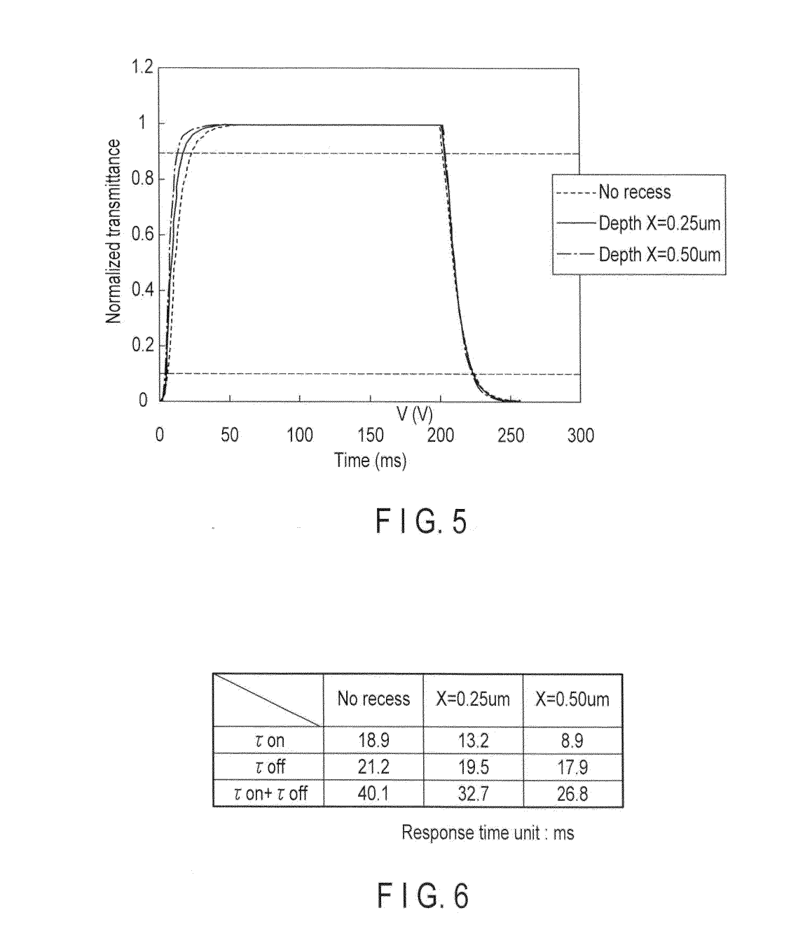

FIG. 5 is a graph showing an example of the simulation result of the change in normalized transmittance with time.

FIG. 6 is a table showing the simulation result shown in FIG. 5, i.e., showing a time τon required for the transmittance to reach 0.9 from 0.1 when the voltage was ON, a time τoff required for the transmittance to reach 0.1 from 0.9 when the voltage was OFF, and the sum of these times.

According to this simulation result, as the depth X of the recess 200 increased, the time τon when the power supply was ON and the time τoff when the power supply was OFF shortened, and the response of the liquid crystal increased.

The time τon shortened when the recesses 200 were formed probably because an electric field on the side of the first substrate 101, among electric fields generated between the comb pixel electrode PEA and comb common electrode CEA, was used to modulate the liquid crystal, so the electric field to be used to modulate the liquid crystal became intense even at the same voltage.

The time τoff shortened when the recesses 200 were formed perhaps because the cell gap on the comb pixel electrode PEA and comb common electrode CEA decreased, and the anchoring effect occurred on the sidewalls of the recess 200.

Note that in the above simulation, the distance Y from the bottom surface of the recess 200 to the second substrate 102 was held constant, and the depth X of the recess 200 was changed. Simulation in which the distance from the surfaces of the comb pixel electrode PEA and comb common electrode CEA to the second substrate 102 was held constant and the depth X of the recess 200 was increased will be explained below.

In this case, the larger the depth X of the recess 200, the larger the average value of the cell gaps. Therefore, the refractive-index anisotropy Δn is decreased when the retardation (Δn·d) of the liquid crystal is held constant. Generally, the viscosity of a liquid crystal decreases as the refractive-index anisotropy Δn decreases, and the response time improves when the viscosity decreases.

That is, in the liquid crystal display of this embodiment, among electric fields generated between the comb pixel electrode PEA and comb common electrode CEA, an electric field on the side of the first substrate 101 contributes to modulation. This makes it possible to decrease the driving voltage, and increase the response speed of a liquid crustal. Accordingly, this embodiment can provide a liquid crystal display capable of reducing the driving voltage and improving the display quality.

While certain embodiments have been described, these embodiments have been presented by way of example only, and are not intended to limit the scope of the inventions. Indeed, the novel embodiments described herein may be embodied in a variety of other forms; furthermore, various omissions, substitutions and changes in the form of the embodiments described herein may be made without departing from the spirit of the inventions. The accompanying claims and their equivalents are intended to cover such forms or modifications as would fall within the scope and spirit of the inventions.

What is claimed is:

1. A liquid crystal display comprising:
a first substrate comprising a pixel electrode including a plurality of comb pixel electrodes, a common electrode including a plurality of comb common electrodes arranged between the plurality of comb pixel electrodes such that predetermined spaces are formed between the plurality of comb pixel electrodes and the plurality of comb common electrodes, and a recess formed between and along the comb pixel electrode and the comb common electrode;
a second substrate opposing the first substrate; and
a liquid crystal layer held between the first substrate and the second substrate.

2. The display according to claim 1, wherein
the first substrate comprises a plurality of insulating layers as underlayers of the comb pixel electrodes and the comb common electrodes, and
at least one of the plurality of insulating layers is removed in the recess.

3. The display according to claim 1, wherein a transverse electric field generated between the comb pixel electrode and the comb common electrode controls an alignment state of a liquid crystal.

4. The display according to claim 2, wherein a transverse electric field generated between the comb pixel electrode and the comb common electrode controls an alignment state of a liquid crystal.
